(19) United States
(12) Patent Application Publication
(10) Pub. No.: US 2021/0206198 A1
(43) Pub. Date: Jul. 8, 2021

(54) WHEEL FOR A COMMERCIAL VEHICLE, AND USE THEREOF

(71) Applicants: THYSSENKRUPP STEEL EUROPE AG, Duisburg (DE); thyssenkrupp AG, Essen (DE)

(72) Inventor: David PIERONEK, Dortmund (DE)

(73) Assignees: THYSSENKRUPP STEEL EUROPE AG, Duisburg (DE); thyssenkrupp AG, Essen (DE)

(21) Appl. No.: 16/073,455

(22) PCT Filed: Feb. 3, 2017
(86) PCT No.: PCT/EP2017/052313

§ 371 Date: Jul. 27, 2018

(30) Foreign Application Priority Data
Feb. 10, 2016 (DE) 10 2016 202 005.6

(51) Int. Cl. B60B 3/08; B60B 3/00; B21K 1/28

(52) U.S. Cl. CPC B60B 3/087; B60B 3/004; B21K 1/28; B60B 2310/212; B60B 2310/208; B60B 2310/211; B60B 2360/102

(57) ABSTRACT

A commercial vehicle wheel including a rim configured to hold a tire and a wheel disc attached to the rim with an attachment region for removable attachment to a wheel carrier. The wheel disc is formed from at least two parts, which are joined together. At least one of the parts consists of a multiphase steel alloy or a heat-treatable steel alloy.

The invention relates to a commercial vehicle wheel comprising a rim to hold a tire and a wheel disc attached to the rim with an attachment region for removable attachment to a wheel carrier, wherein the wheel disc is formed from at least two parts, which are joined together. Moreover, the invention relates to a use of the commercial vehicle wheel.

Conventionally, the commercial vehicle wheels, such as truck wheels, are made of a steel material and consist of a rim to hold a tire and a wheel disc attached to the rim with an attachment region for removable attachment to a wheel carrier. Both the wheel disc and the rim can be produced by means of flow forming. For example, the wheel disc in the attachment region to the wheel carrier, which must have a minimum thickness to absorb mechanical loads such as dynamic alternating stresses, has roughly twice the material thickness as compared to the transition region for attachment to the rim. Flow forming therefore has the advantage that the material during the shaping process can be pressed optimally in terms of loading and/or weight at critical loading sites when using a steel material with a constant starting material thickness, so that different material thicknesses can be produced along the cross section at the wheel disc and also at the rim, which may contribute to a weight reduction as compared to wheel discs and/or rims with a constant material thickness. Conventionally used steel materials are, for example, soft unalloyed steels or general structural steels (see, for example, p. 7-8, “Warmgewalzter Bandstahl [“Hot-rolled band steel”]” Hohenlimburger Mittelband, 2005 edition, http://www.hoesch-hohenlimburg.de/projekt/web2013/HHOWebCMS.nsf/$All/5FBA8E2A70F31505C12570F5004AB5F2/$FILE/Warmbandd.pdf), in which case their material thickness at least in the attachment region to the wheel carrier has a thickness of greater than 10 mm, in particular of 14.2 mm, in order to meet the relevant safety requirements.

Lightweight potential is available today with steel alloy concepts such as multiphase steel alloys or heat-treated steel alloys, which may have high strengths in the final state and are used in areas where existing material concepts with low strength, for example, can be replaced. Thanks to the substitution, the material thicknesses in the design of structural parts with substantially the same performance can be reduced on account of the higher strengths, which thus have beneficial effects on the reduction of the overall weight. The available material thicknesses of such steel alloy concepts, in particular the multiphase steel alloys, are limited by the production method. Appropriate process management provides these alloys with the desired properties, but they may vary over the cross section with increasing material thickness and at present material thicknesses of for example >8 mm are not technically or economically feasible.

From German patent 40 25 064 there is known a method for production of commercial vehicle wheels, in particular for production of the wheel discs of commercial vehicle wheels. It had already been known that, in the case of using workpieces with constant material thickness, the shoulder region, i.e., the transition region for attachment to the rim, is overdimensioned and this therefore comes at the expense of the weight of the wheel. It is proposed in this document to provide a wheel disc composed of several parts, having a first part forming for example a base support of the wheel disc and covering substantially both attachment regions. Since high strengths and stiffnesses are required in the attachment region to the wheel carrier, the wheel disc must also have a minimum thickness in this region, which is provided by a doubling of material from parts made of a hot-rolled steel, in particular for strengthening of the attachment region, and which are integrally bonded together. In order to reduce the scrap fraction of the hot-rolled steel, the individual components are punched out from a hot-rolled steel as required, assembled into a ring, and joined to the first part (base support) in order to strengthen the attachment region to the wheel carrier. In order to reduce the multitude of required hot-rolled steels for the different commercial vehicle wheels, the teaching further proposes using the same material and the same material thickness for the individual parts of the strengthening ring and also for the first part. Further potential for improvement exists in regard to the prior art, in particular in regard to a further weight reduction for commercial vehicle wheels.

The problem which the invention was meant to solve was that of providing a commercial vehicle wheel which can be designed in an optimized manner for loading and/or weight as compared to the known prior art, as well as indicating a corresponding use.

According to a first aspect of the invention, the problem is solved according to the commercial vehicle wheel according to the invention in that at least one of the parts consists of a multiphase steel alloy or a heat-treatable steel alloy.

The inventor has surprising found through his own investigations that by the use of a multiphase steel alloy or heat-treatable (hardenable) steel alloy for at least one of the parts which form at least one component of the wheel disc, a steel alloy is used which has higher strength as compared to the conventionally used material (unalloyed steels or band steels). Thus, small material thicknesses can be used for substantially comparable or the same performance, with beneficial effect on the reduction of the overall weight. The at least two parts of the wheel disc are at least a first part and a second part.

According to a first embodiment of the commercial vehicle wheel according to the invention, the multi-phase steel alloy is a dual-phase steel, a complex-phase steel, a ferrite-bainite steel or a martensite-phase steel alloy, and the tensile strength of the multi-phase steel alloy is at least 500 MPa, preferably at least 600 MPa and particularly preferably at least 700 MPa, wherein the structure of the multiphase steel alloy consists of at least two of the phases: ferrite, bainite, austenite or martensite. The heat-treatable (hardenable) steel alloy is a hot forming steel or air hardening steel alloy with a tensile strength of at least 700 MPa, preferably at least 800 MPa and particularly preferably at least 900 MPa, wherein the structure of the heat-treatable steel alloy consists predominantly of martensite, in particular more than 90% of the structure consists of martensite. With increasing strength, for substantially the same performance, the respective material thickness can be reduced and in this way the weight can be further decreased. The aforesaid steel alloys have higher cyclic bending fatigue strengths as compared to the steel concepts conventionally used, which can in particular increase the service life of corresponding components and can substantially prevent in particular a premature material failure. It has been discovered in numerous investigations, in which samples (sample strips) were clamped at one end in a suitable measuring device and subjected at the opposite, free end to a sinusoidal loading (alternating loading), that multiphase steel alloys, in particular the aforementioned ones, have on average at least twice, and heat-treated steel alloys have on average at least three times, the cyclic bending fatigue strength than the steel alloys conventionally used for wheel discs.

According to another embodiment of the commercial vehicle wheel according to the invention, the at least two parts each consist of a multiphase steel alloy or a heat-treatable steel alloy. This has the advantage in particular of outfitting the wheel disc with one or different steel alloys individually through the parts and thereby with the same or different properties (tailor-made properties), which provides further potential for lightweight design.

According to another embodiment of the commercial vehicle wheel according to the invention, the wheel disc is substantially shell-shaped, having a center region with a center opening and a peripheral web region, in which several openings arranged round the center opening are provided for receiving connection means, wherein at least a portion of the web region forms the attachment region for removable attachment to a wheel carrier, and a collar region radially projecting onto the web region, in which openings are optionally provided, wherein the collar region comprises an end region forming the transition region for attachment to a rim, in particular wherein the web region and the end region are formed by at least a first part of the wheel disc. Preferably, the first part of the wheel disc is configured as a base support. The web region may for example be configured at least partly planar, in order to be able to provide a certain attachment surface (contact surface) for the wheel carrier. Depending on the commercial vehicle wheel type, openings may be provided in the collar region, which function for example as ventilation holes and/or can additionally reduce the weight of the commercial vehicle wheel by specific cut-out or omission of material.

According to another embodiment of the commercial vehicle wheel according to the invention, at least one second part of the wheel disc is substantially ring-shaped and formed in particular as a single piece and is arranged at least for a section in the web region on the side facing the wheel carrier or at least for a section in the web region on the side facing away from the wheel carrier. The arrangement of the second part on the side facing the wheel carrier has the advantage that, in particular if the second part has a higher strength or less breaking elongation than the first part, a local plasticization of the wheel disc in the region of the contact surface with the wheel carrier can be substantially prevented. However, if the second part has a lower strength and therefore a greater breaking elongation as compared to the first part, this has the advantage, for example, that local peak stresses in the region of the contact surface with the wheel carrier can be evened out or for the most part distributed into the surrounding region, so as to reduce the notch sensitivity. The alternative arrangement of the second part on the side facing away from the wheel carrier has for example the advantage that, in particular if the second part has a higher strength or a smaller breaking elongation than the first part, a higher pretensioning force of the connection means (bolts/screws) can be implemented. However, if the second part has a lower strength and therefore a greater breaking elongation as compared to the first part, this has the advantage, for example, that local peak stresses in the region of the attachment surface of the connection means can be evened out or for the most part distributed into the surrounding region, so as to reduce the notch sensitivity. In one preferred embodiment, the second part of the wheel disc protrudes into the collar region and is arranged at least for a section in the collar region of the wheel disc, thereby making possible an additional strengthening of the collar region at least for a section.

In order to substantially eliminate a sudden change in stiffness in the wheel disc from the region of the material doubling to the first part (base support), a harmonic stiffness gradation can be achieved by a structural configuration, for example, by a stiffening wave, embossing and/or introducing of a phase into the second part (strengthening part) or on its peripheral edge. Alternatively or cumulatively, an integrally bonded or non-positive connection can be generated in this region in order to relieve this region of load.

According to another embodiment of the commercial vehicle wheel according to the invention, at least one third part of the wheel disc is substantially ring-shaped and formed in particular as a single piece, the third part being arranged at least for a section in the web region of the wheel disc on the side situated opposite the second part. A material tripling created in this way, which is provided at least locally in the attachment region to a wheel carrier, enables for example an optimal design of the wheel disc, so that according to a preferred embodiment the first part of the wheel disc has a greater strength and thus a high cyclic bending fatigue strength, for example due to a hot-formed steel alloy, in particular in the hardened state. The high cyclic bending fatigue strength has a positive effect on the transmission of forces with frequent load changes from the rim to the wheel carrier. The second and the third part of the wheel disc consist for example of a multiphase steel alloy, in particular one with a lower strength as compared to the first part, which may advantageously influence the local stress peaks both on the side with the attachment surface of the connection means and on the side with the contact surface to the wheel carrier.

According to another embodiment of the commercial vehicle wheel according to the invention, the parts/materials, in particular the first and the second part/material, at first are each individually formed for example by means of pressure forming, tensile forming, tensile compressive forming, bend forming, shear forming, flow forming and/or deep drawing, in particular by means of hot forming with at least partial press hardening, and are then joined together to create the wheel disc. A combination of the mentioned methods to create the individual parts is also conceivable. The wheel disc is attached to the rim and possibly other parts as a “built-on” design or alternatively the individual parts of the wheel disc are joined together in the course of the attachment to the rim.

According to another embodiment of the commercial vehicle wheel according to the invention, the parts/materials are formed together in the state in particular joined together by means of pressure forming, tensile forming, tensile compressive forming, bend forming, shear forming, flow forming and/or deep drawing, in particular by means of hot forming with at least partial press hardening to create the wheel disc. A combination of the mentioned methods to create the wheel disc is also conceivable. The wheel disc consisting of at least two parts is attached to the rim and possibly other parts.

According to another embodiment of the commercial vehicle wheel according to the invention, the at least two parts of the wheel disc are joined together by integral bonding, nonpositive and/or positive locking. According to the most simple embodiment, a small second part for the stiffening of the finally formed web region of the wheel disc at least for a section is integrally bonded together with a first part, at least for a section, before and/or after the forming, both parts being formed as starting material of substantially round or circular shape, preferably ring-shaped. The second part may be joined to the first part at least for a section, in particular all around the edge of the second part, by a fillet, which can be made as a MIG, MAG, laser or solder seam. Alternatively or cumulatively, other forms of seams or joining methods are also conceivable, such as friction stir welding, resistance spot welding, or mechanical joining methods. In particular, a polymer layer or textured paint may also be arranged in the entire contact region between the two parts, which may prevent the ingress of spray water in particular and resulting corrosion between the parts of the wheel disc in later use. The polymer layer may consist of a silicone-containing layer, for example a silicone adhesive film, which is suited to both thermal welding and soldering.

The second aspect of the invention relates to a use of a commercial vehicle wheel according to the invention in trucks, special vehicles, buses, coaches, with internal combustion engine and/or electric drive, or trailers. Advantageously, the commercial vehicle wheel according to the invention is used in particular at least as part of a twin wheel.

In the following, the invention will be explained more closely with the aid of a drawing depicting sample embodiments. The same parts are given the same reference numbers. In the drawing:

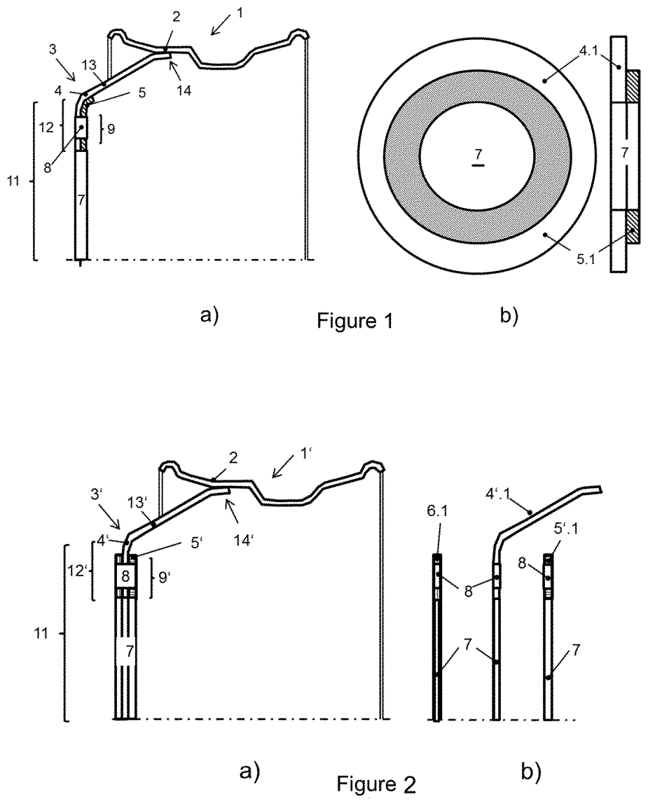

FIG. 1a) shows a schematic cross section through a first sample embodiment of a commercial vehicle wheel according to the invention,

FIG. 1b) shows a first starting material in top view and in cross section for the production of a wheel disc according to the embodiment in FIG. 1a),

FIG. 2a) shows a schematic cross section through a second sample embodiment of a commercial vehicle wheel according to the invention,

FIG. 2b) shows a second starting material in cross section for the production of a wheel disc according to the embodiment in FIG. 2a), and

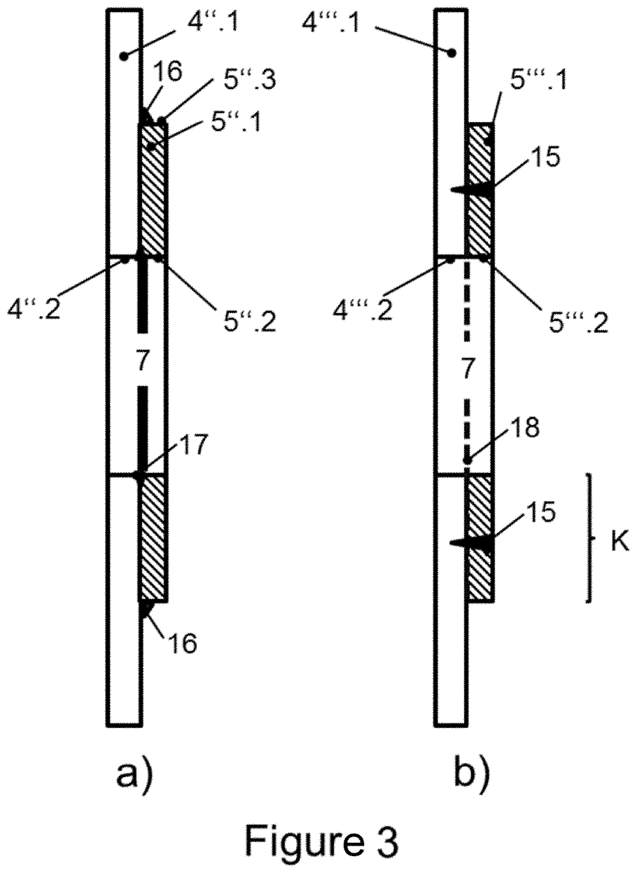

FIGS. 3a) and 3b) show schematic cross sections through a third and fourth starting material for the production of a wheel disc.

FIG. 1a) shows a cross section through a first sample embodiment of a commercial vehicle wheel (1) according to the invention, wherein because of the rotationally symmetrical design only the upper region of the commercial vehicle wheel (1) above the axis of symmetry (10) is depicted. The commercial vehicle wheel (1) comprises a rim (2) to hold a tire, not shown, and a wheel disc (3) attached to the rim (2). The wheel disc (3) consists of or is formed from two parts (4, 5), which are joined together. The connection to one another may be integral bonding, positive and/or non-positive locking. The wheel disc (3) is substantially shell-shaped. The wheel disc comprises a center region (11) with a center opening (7) and a peripheral web region (12), in which several openings (8) arranged round the center opening (7) are provided for receiving connection means, not shown, such as for example bolts and/or screws. At least a portion of the web region (12) forms the attachment region (9) for removable attachment to a wheel carrier. The wheel disc (3) moreover comprises a collar region (13) radially projecting onto the web region (12), in which openings may be provided, which function for example as ventilation holes and/or by specific cut-out or omission of material provide additional weight savings. The collar region (13) comprises an end region (14) forming the transition region for attachment to the rim (2). The web region (12) and the end region (14) are formed by at least the first part (4) of the wheel disc (3), in particular at least the first part (4) extends between the two attachment regions (9, 14). Preferably, the first part (4) is configured as the base support of the wheel disc (3). The web region (12) is configured for example at least partly planar, in order to provide a certain attachment surface (contact surface) to the wheel carrier. The second part (5) of the wheel disc (3) is substantially ring-shaped and formed in particular as a single piece and is arranged entirely in the web region (12) or covers it entirely, wherein the second part (5) is arranged on the side facing the wheel carrier. In particular by the material doubling thanks to the first and the second part (4, 5), the wheel disc (3) is given a certain stiffness in the web region (12) and in the attachment region (9), respectively, for removable attachment to a wheel carrier. For the at least partial strengthening of the collar region (13), the second part (5) of the wheel disc (3) protrudes into the collar region (13) or is situated at least for a section in the collar region (13) of the wheel disc (3). Alternatively, and not represented here, the second part of the wheel disc may be arranged on the side facing away from the wheel carrier at least for a section in the web region. Owing to the use of a multiphase steel alloy or heat-treatable steel alloy for at least one of the parts (4, 5) which form at least one component of the wheel disc (3), a steel alloy is used which has a higher strength as compared to the conventionally used material (unalloyed steels or structural steels). In this way, small material thicknesses may be used for substantially comparable or the same performance, which on the one hand have an advantageous effect on a reduction of the overall weight and on the other hand have higher cyclic bending fatigue strengths, which increase in particular the service life of the corresponding parts (4, 5) and in particular substantially prevent a premature material failure.

FIG. 1b) shows a first starting material in schematic top view and in cross section for the production of the wheel disc (3). The starting material consists of a first, flat and ring-shaped material (4.1) and a second, flat and ring-shaped material (5.1), the second material (5.1) being of smaller dimensions than the first material (4.1) and being connected in the web region (12) to be created by non-positive locking, positive locking and/or integral bonding to the first material (4.1) to increase the stiffness of the attachment region (9) to be created on the wheel disc (3). The embodiment corresponds for example to a tailored product, for example a patchwork blank. The center opening (7) may be punched out each time before or after the connecting of the two materials (4.1, 5.1). The first material (4.1) consists of a multi-phase steel alloy, such as a dual-phase steel alloy, a complex-phase steel alloy, a ferrite-bainite steel alloy or a martensite-phase steel alloy with a tensile strength of at least 500 MPa, preferably at least 600 MPa, particularly preferably at least 700 MPa, wherein the structure of the multiphase steel alloy consists of at least two of the phases: ferrite, bainite, austenite or martensite, or it consists of a heat-treatable steel alloy, such as a hot forming steel or air hardening steel alloy with a tensile strength of at least 700 MPa, preferably at least 800 MPa, particularly preferably at least 900 MPa, wherein the structure of the heat-treatable steel alloy consists predominantly of martensite, in particular more than 90% consists of martensite. The thickness of the first material (4.1) depending on the design of the commercial vehicle wheel is between 3 and 8 mm. The second material (5.1) may consist of a multiphase steel alloy or a heat-treatable steel alloy, wherein the material (5.1) is identical to the first material (4.1) or differs in regard to at least one property, such as strength and/or breaking elongation, from the first material (4.1). The thickness of the second material (5.1) is between 3 and 8 mm. It is also conceivable to use the heretofore conventional steel alloys as the second material (5.1). By means of pressure forming, tensile forming, tensile compressive forming, bend forming, shear forming, flow forming and/or deep drawing, in particular by means of hot forming with at least partial press hardening, the two materials/parts (4.1, 5.1) are formed in the joined-together state for the creation of the wheel disc (3). The wheel disc (3) consisting of two parts (4, 5) is attached to the rim (2) to create a commercial vehicle wheel (1) (see FIG. 1a)).

FIG. 2a) shows a second sample embodiment of a commercial vehicle wheel (1′) according to the invention. Unlike the first sample embodiment, the wheel disc (3′) is formed or consists of three parts (4′, 5′, 6). The wheel disc (3′) is substantially shell-shaped, comprising a center region (11) with a center opening (7) and a peripheral web region (12), in which several openings (8) arranged round the center opening (7) are provided to receive connection means, not shown. At least a portion of the web region (12) forms the attachment region (9′) for removable attachment to a wheel carrier. The wheel disc (3′) moreover comprises a collar region (13′) radially projecting onto the web region (12′), and comprises an end region (141 forming the transition region for attachment to the rim (2′). The web region (12′) and the end region (14′) are formed by at least the first part (4′) of the wheel disc (3′), in particular at least the first part (4′) extends between the two attachment regions (9′, 14′). Preferably, the first part (4′) is configured as the base support of the wheel disc (3′). The second part (5′) of the wheel disc (3′) is substantially ring-shaped and formed in particular as a single piece and is arranged entirely in the attachment region (9′) of the web region (121 while the second part (5′) is arranged on the side facing the wheel carrier. The third part (6) of the wheel disc (3′), which is substantially ring-shaped and formed in particular as a single piece, is arranged at least for a section in the web region (12′) on the side situated opposite the second part (5′) of the wheel disc (3′), in this example on the side facing away from the wheel carrier.

FIG. 2b) shows the starting materials for the production of the wheel disc (3′) in schematic cross section. The starting materials consist of a first, shell-shaped material (4′.1), which substantially already corresponds to the geometry of the first part (4′) and thus forms the base support of the wheel disc (3′), a second flat and ring-shaped material/part (5′.1), and a third flat and ring-shaped material/part (6.1). The second and third material/part (5′.1, 6.1) are preferably formed as a single piece, having the same geometry and smaller dimensions than the first material (4′.1) and being joined by non-positive locking, positive locking, and/or integral bonding to the first material (4′.1) in order to increase the stiffness of the attachment region (9′) to be created on the wheel disc (3′) in the web region (12′). The center opening (7) in this example was punched out prior to the connecting of the three materials (4′.1, 5′.1, 6.1). The first material (4′.1) consists of a multiphase steel alloy or a heat-treatable steel alloy. The thickness of the first material (4′.1), depending on the design of the commercial vehicle wheel, is between 3 and 8 mm. The second and/or the third material (5′.1, 6.1) may consist of a multiphase steel alloy or a heat-treatable steel alloy. The thickness of the second and/or third material (5′.1, 6.1) is between 3 and 8 mm. By means of pressure forming, tensile forming, tensile compressive forming, bend forming, shear forming, flow forming and/or deep drawing, in particular by means of hot forming with at least partial press hardening, at least the first material (4′.1) is converted into a geometry which substantially corresponds to the geometry of the first part (41 and thus preferably to the geometry of the base support of the wheel disc (3′). The second and the third material (5′.1, 6.1) are joined by non-positive locking, positive locking, and/or integral bonding to the first material (4′.1) or part (4.1) for the partial stiffening of the substantially finally shaped web region (121 wherein they need not be converted into a flat shape, depending on the design, but rather may also have a preliminary geometry or a final geometry. The openings (8) for receiving the connection means can, as shown in this sample embodiment, be respectively made before or alternatively after the joining of the materials (4′.1, 5′.1, 6.1). The wheel disc (3′) “built” from the individual, partly shaped materials (4′.1, 5′.1, 6.1) is attached to the rim (2′) in order to create a commercial vehicle wheel (1′) (see FIG. 2a)).

FIGS. 3a) and 3b) show a third and fourth starting material in schematic cross section for the production of a wheel disc. Both starting materials consist respectively of a first material (4″.1, 4′″.1), which consists of a multiphase steel alloy with a tensile strength of at least 500 MPa or of a heat-treatable steel alloy with a tensile strength of at least 700 MPa, and a second material (5″.1, 5″.1), which in turn may consist of a multiphase steel alloy or a heat-treatable steel alloy. The materials (4″.1, 4′″.1, 5″.1, 5″.1) are formed flat, ring-shaped, and substantially round or circular.

FIG. 3a) shows that the second material (5″.1) is joined by integral bonding to the first material (4″.1) at least partly, in particular entirely all around the (outer) edge (5″.3) of the second material (5″.1) by a fillet 16, which can be produced as a MIG, MAG, laser or solder seam. Another connection seam 17, which is provided at least partly, in particular entirely all around the (inner) edges (4″.2, 5″.2) of the two materials (4″.1, 5″.1), where the (inner) edges (4″.2, 5″.2) define the center opening (7), in addition to strengthening the connection between the two materials/parts, can also provide a seal between them.

FIG. 3b) shows that in the fourth starting material, unlike the third starting material, the second material (5′″.1) is joined by integral bonding to the first material (4′″.1) by discrete weld spots 15 arranged round the center opening (7). In addition, a polymer layer (18) is arranged in the entire contact region (K) between the two materials (4′″.1, 5′″.1), which may prevent the intrusion of spray water in particular and the concomitant corrosion between the parts of the finally shaped wheel disc in its later use. The polymer layer (18) consists for example of a silicone-containing layer, which is suitable for thermal welding as well as soldering, in particular. The third and fourth starting material are hot- or cold-formed preferably by means of flow forming into a wheel disc (see FIG. 1a). Alternatively, deep drawing may also be performed, in particular hot forming with at least partial press hardening, to create a wheel disc.

The invention is not confined to the sample embodiments presented in the drawing or to the embodiments in the general description, but instead the rim 2, 2′ may also consist of a multiphase steel alloy or heat-treatable steel alloy and be designed for optimal loading and/or weight preferably by means of flow forming. Moreover, parts or the starting material for the creation of the wheel disc and/or the rim may be formed from tailored products, such as tailored blanks, tailored rolled blanks and/or patchwork blanks.

### LIST OF REFERENCE NUMBERS

1, 1′ Commercial vehicle wheel
2, 2′ Rim
3, 3′ Wheel disc
4, 4′ First part of the wheel disc, base support of the wheel disc
4.1, 4′.1, 4″.1, 4′″.1 First material
4″.2, 4″.2 (Inner) edge of first material
5, 5′ Second part of the wheel disc
5.1, 5′.1, 5″.1, 5′″.1 Second material
5″.2, 5″.2 (Inner) edge of second material
5″.3 (Outer) edge of second material
6 Third part of the wheel disc
6.1 Third material
7 Center opening
8 Opening to receive connection means
9, 9′ Attachment region
10 Axis of symmetry
11 Center region
12, 12′ Web region
13, 13′ Collar region
14, 14′ End region, transition region to attachment
15 Weld spot
16 Fillet
17 Connection seam
18 Polymer layer
K Contact region

1.-11. (canceled)

12. A commercial vehicle wheel, comprising:
a rim configured to hold a tire, and
a wheel disc attached to the rim, the wheel disc including an attachment region configured to removably attach to a wheel carrier, wherein the wheel disc is formed from at least two parts, which are joined together,
wherein at least one of the wheel disc parts consists of a multiphase steel alloy or a heat-treatable steel alloy.

13. The commercial vehicle wheel of claim 12, wherein the multiphase steel alloy is a dual-phase steel, a complex-phase steel, a ferrite-bainite steel or a martensite-phase steel alloy, wherein the structure of the multiphase steel alloy consists of at least two of the phases: ferrite, bainite, austenite or martensite, or the heat-treatable steel alloy is a hot forming steel or air hardening steel alloy, wherein the structure of the heat-treatable steel alloy consists predominantly of martensite.

14. The commercial vehicle wheel of claim 13, wherein the multiphase steel alloy has a tensile strength of at least 500 MPa.

15. The commercial vehicle wheel of claim 13, wherein the heat-treatable steel alloy has a tensile strength of at least 700 MPa.

16. The commercial vehicle wheel of claim 13, wherein more than 90% of the structure of the heat-treatable steel alloy consists of martensite.

17. The commercial vehicle wheel of claim 12, wherein the at least two parts each consist of a multiphase steel alloy or a heat-treatable steel alloy.

18. The commercial vehicle wheel of claim 12, wherein the wheel disc is substantially shell-shaped, having a center region with a center opening and a peripheral web region, in which several openings arranged round the center opening are provided for receiving connection means, wherein at least a portion of the web region forms the attachment region for removable attachment to a wheel carrier, and a collar region radially projecting onto the web region, wherein the collar region comprises an end region forming the attachment region to a rim.

19. The commercial vehicle wheel of claim 18, wherein the web region and the end region are formed by at least a first part of the wheel disc.

20. The commercial vehicle wheel of claim 12, wherein at least one second part of the wheel disc is substantially ring-shaped and formed in particular as a single piece and is arranged at least for a section in the web region on the side facing the wheel carrier or at least for a section in the web region on the side facing away from the wheel carrier.

21. The commercial vehicle wheel of claim 20, wherein the second part of the wheel disc protrudes into the collar region and is arranged at least for a section in the collar region of the wheel disc.

22. The commercial vehicle wheel of claim 20, wherein at least one third part of the wheel disc is substantially ring-shaped and formed as a single piece and is arranged at least for a section in the web region on the side situated opposite the second part of the wheel disc.

23. The commercial vehicle wheel of claim 12, wherein the parts at first are each individually formed by pressure forming, tensile forming, tensile compressive forming, bend forming, shear forming, flow forming and/or deep drawing.

24. The commercial vehicle wheel of claim 23, wherein the parts at first are each individually formed by hot forming with at least partial press hardening and are then joined together to form the wheel disc.

25. The commercial vehicle wheel of claim 12, wherein the materials are formed together in the state by pressure forming, tensile forming, tensile compressive forming, bend forming, shear forming, flow forming and/or deep drawing.

26. The commercial vehicle wheel of claim 25, wherein the materials are joined together.

27. The commercial vehicle wheel of claim 25, wherein the materials are formed together by hot forming with at least partial press hardening to form the wheel disc.

28. The commercial vehicle wheel of claim 12, wherein the at least two parts of the wheel disc are joined together by integral bonding, non-positive and/or positive locking.

29. A commercial vehicle comprising a plurality of commercial vehicle wheels according to the commercial vehicle wheel of claim 12.
